(19) United States
(12) Patent Application Publication
(10) Pub. No.: US 2022/0073313 A1
(43) Pub. Date: Mar. 10, 2022

(54) PASSENGER TRANSPORT SYSTEM

(71) Applicant: Inventio AG, Hergiswil (CH)

(72) Inventor: Philippe Henneau, Zürich (CH)

(21) Appl. No.: 17/309,856

(22) PCT Filed: Dec. 19, 2019
(86) PCT No.: PCT/EP2019/086263

§ 371 Date: Jun. 24, 2021

(30) Foreign Application Priority Data
Dec. 24, 2018 (EP) 18215823.8

(51) Int. Cl. B66B 5/00; B66B 25/00

(52) U.S. Cl. CPC B66B 5/0018; B66B 25/006

(57) ABSTRACT

A device for monitoring an operating state of a control device of a passenger transport system includes a detection unit for generating a first electrical quantity depending on a signaled state of the control device, an evaluation unit for analyzing the first electrical quantity in relation to the operating state of the control device, and an interface for transmitting a second electrical signal that is dependent on the analysis and is generated in the evaluation unit. The detection unit is a conversion device for converting an optical signal of at least one optical indicator of the control device into the first electrical signal. The device for monitoring allows state information on the control device to be tapped without conversion work being required on the control device.

### FIELD

The invention relates to a device for monitoring an operating state of a control device of a passenger transport system, a method for monitoring an operating state of a control device, and a method for retrofitting a passenger transport system.

### BACKGROUND

There is a need to remotely monitor the state of the passenger transport system in order to be able to better coordinate the maintenance of the system.

A device is known from JP2002197215 which taps the state of an elevator system from the system by means of an apparatus of the system in order to then transmit this state to a remote unit.

A device is known from US2015/0293799A1 which taps the state of an elevator installation indicated by LEDs using photosensors in order to subsequently transmit this state to a remote unit.

A device for actively monitoring indicator lamps in an elevator system is known from U.S. Pat. No. 4,555,689.

It has proven to be disadvantageous that subsequently installing a state monitoring and communication apparatus in existing systems is complex. The desire to integrate such monitoring means that details regarding the installed control device have to be known. For example, which electrical signals are relevant and where they can be tapped must be known. The control device then has to be converted, which requires a well-trained service technician. There is the risk that the control device will be damaged. There is a high risk of damage, in particular when the electrical signals are tapped. Since old control devices often contain components that are no longer available, potential damage to the system is particularly problematic. Failure of the control device can lead to the need to replace further structural units, and thus lead to complex conversion work.

### SUMMARY

The problem addressed by the present invention is that of providing a device for monitoring an operating state of a control device of a passenger transport system and a method for monitoring an operating state of a control device, which device avoids the disadvantages of the prior art, and in particular providing a method for retrofitting a passenger transport system which allows state information on the control device to be tapped without conversion work being required on the control device.

The problem is solved by a device for monitoring an operating state of a control device of a passenger transport system, a method for monitoring an operating state of a control device, and a method for retrofitting a passenger transport system according to the following description.

According to the invention, the device for monitoring an operating state of a control device of a passenger transport system comprises a detection unit for generating a first electrical quantity depending on a signaled state of the control device. The device further comprises an evaluation unit for analyzing the first electrical quantity in relation to the operating state of the control device. The device also comprises an interface for transmitting a second electrical signal that is dependent on the analysis and is generated in the evaluation unit. According to the invention, the detection unit is a conversion device for converting an optical signal of at least one optical indicator of the control device into the first electrical signal.

The passenger transport system is preferably an elevator or escalator system.

In a simple embodiment, the evaluation unit is a voltage source having a fixed output voltage. According to the invention, the conversion device is a photoelectric element, for example a phototransistor, preferably a photoresistor, that is connected to the voltage source (evaluation device). The photoelectric element has a different state (for example, a different resistance) depending on the state of the optical indicator. The resistance of the photoelectric element is the first electrical quantity in this embodiment. The current resulting from the photoelectric element on the basis of the output voltage changes depending on the state of the optical identifier. This current is the second electrical quantity.

In the previously described embodiment of the evaluation unit, the interface for transmitting a second electrical quantity, which is dependent on the analysis and is generated in the evaluation unit, can be designed as two terminals for conducting said current (second electrical quantity). An analog transmission of the second electrical quantity thus takes place via cables that are connected to the terminals. The second electrical quantity can then be further analyzed and processed outside the device.

Such a device allows a state of the control device to be digitized without an electrical signal of the device having to be tapped for this purpose. Only one optical signal (or a plurality thereof), which is indicated in the control device by an LED (or a plurality thereof), for example, is detected by the conversion device. The information from the optical indicator is thus converted into an electrical quantity (or a plurality thereof), which can then be easily evaluated. There is no need to intervene in the existing control device, as a result of which, inter alia, it is impossible to damage the control device. The device thus provides a simple and non-intrusive way to digitize state information from old control devices. Digital services can thus also be offered in a simple manner for existing passenger transport systems, which is otherwise only possible for new systems with interfaces specially provided for this purpose. For example, the use of service technicians can be better planned by digitizing the optical state information. In this way, the service technician can get an initial picture of the system based on the digitized state information transmitted in this digital form before going into the field. This takes place in the same way that an overview is provided on site, when the service technician quickly determines where the possible problem could be, based on the optical indicators. Due to the device, the service technician can do this remotely. Based on the optical state displays, it is possible to infer what type of disturbance the disturbance in question may be. The service technician can thus already plan their call in the service center and organize any material that may be required, so that an efficient service call is then possible.

In a further embodiment, the detection unit is designed as a photoelectric element that generates an analog electrical signal depending on the detected optical indicator, and an analog/digital converter that converts the analog signal into a digital value. In this embodiment, the first electrical quantity is this digital value. In this embodiment, the evaluation unit is a microprocessor that further processes the digital value and prepares it for transmission. In this embodiment, the processed value is the second electrical quantity. Said electrical quantity is transmitted via the interface for transmission, which is designed, for example, as a communication unit. This can take place via the Internet, for example, so that the second electrical quantity is available at a location remote from the device.

The processing of the converted optical signal can thus take place almost exclusively outside the device (first embodiment mentioned) or almost exclusively within the device (second embodiment mentioned). Any gradations are possible.

In a preferred embodiment, the conversion device comprises a photoresistor and/or a camera.

In a preferred embodiment, the conversion device can be mounted in a control device housing. The conversion device is designed such that a plurality of optical indicators in the control device housing can be monitored thereby.

A photoresistor is a compact and cost-effective embodiment of a conversion device. A camera allows a wide field of view to be detected and, by means of image processing, allows the identification of all conceivable optical indicators and their changes in state in the field of view. A combination of one or more photoresistors and one or more cameras thus allows a large number of optical indicators to be detected. For example, there can be a photoresistor for each classic optical indicator, i.e. optical indicators that are present in almost every control device. Each of these photoresistors is used to detect a specific optical indicator. In addition to these photoresistors, a camera can be present which is oriented relative to the photoresistors such that all other optical indicators not detected by a photoresistor, for example indicators specific to a type of control device, are detected by the camera. In this way, a flexible conversion device is provided, by means of which a large number of different control devices can be reliably detected.

According to the invention, the conversion device has a plug-in device that can be plugged onto at least one optical indicator of the control device.

According to the invention, the plug-in device has a photoelectric element for monitoring this indicator on a first side that, in the plugged-on state, faces the optical indicator onto which the plug-in device is plugged.

It can thus be ensured that the conversion device is correctly placed in relation to the optical indicator (or a plurality thereof). In particular, it can thus be ensured that the conversion device is placed at a distance from the optical indicator at which the optical indicator can be reliably detected without any problems. It can further be guaranteed that the photosensitive surface of the photoelectric element faces the optical indicator.

In one embodiment, the plug-in device of the conversion device is designed such that the photoelectric element (or a plurality thereof) comes to rest directly on the corresponding optical indicator, for example an LED. This ensures that the photoelectric element can detect the relevant optical indicator easily and without any interference from other optical indicators.

In one embodiment, a plurality of photoresistors is used, the photoresistors being designed for different frequency ranges. For example, a photoresistor for detecting red LEDs and a photoresistor for detecting green LEDs may be present.

In one embodiment, the conversion device is designed as a plurality of photoelectric elements that can be plugged onto LEDs.

In a preferred embodiment, the plug-in device has a camera for monitoring at least one further optical indicator on a second side that, in the plugged-on state, faces away from the optical indicator onto which the plug-in device is plugged.

It has proven to be advantageous that, in addition to the indicator (or a plurality thereof) onto which the plug-in device is plugged, optical indicators that are present at other locations can thus be monitored by the wide field of view of the camera.

A method for monitoring an operating state of a control device of a passenger transport system also leads to the solution of the problem. The method comprises the steps of:
optically monitoring, preferably continuously optically monitoring, at least one optical indicator of the control device;
generating an electrical quantity corresponding to the optical state of the at least one monitored optical indicator;
detecting a change in state of the optical indicator based on changes in the electrical quantity; and
evaluating the detected change in state.

It has proven to be advantageous that an optical indicator can be converted into an electrical quantity and then evaluated by means of the method. The method thus allows control device states to be evaluated without the need for electrical intervention in the control device. The method thus in particular allows the state of existing systems to be subsequently detected in a simple and cost-effective manner.

The electrical quantity corresponds to the optical indicator and therefore provides information about the state of the control device.

In a preferred embodiment, the detection of a change in state of the optical indicator comprises identifying changes in the color and/or state change patterns. The detection can in particular comprise identifying on-off patterns and/or intensity change patterns. The detection can also comprise the recognition of a one-time switch-off and/or switch-on. The detection comprises identifying all common changes in state of optical indicators.

In a preferred embodiment, in a learning phase of the method, the evaluation of the detected changes in state is used to define states of the control device.

By means of the learning phase, the method can be applied to any control device without prior study of the control device and the optical indicators thereof. In an initial phase, the method learns, on the basis of predominantly prevailing states and, if appropriate, data from further sensors of the passenger transport system, which indicator represents which operating state in which state. The learning phase can in particular be supplemented by data from a central server and the large number of patterns available as a result.

In a preferred embodiment, in a monitoring phase of the method, the evaluation of the detected changes in state is used to identify error states of the control device.

After the learning phase has been completed, states can be inferred based on changes in the optical indicators. This allows simple monitoring of the passenger transport system without electrical signals of the control device having to be tapped for this purpose.

In a preferred embodiment, the method further comprises the step of transmitting the detected changes in state to an entity outside the passenger transport system.

This allows access to state information without having to be present at the passenger transport system itself. This allows, inter alia, remote diagnosis of the passenger transport system.

In a preferred embodiment, the method further comprises the step of resetting the control device when a specific error state of the control device is identified.

This allows a desired state of the control device to be established without the need for manual intervention by a service technician.

A method for retrofitting an existing passenger transport system also leads to the solution of the problem, which method comprises the step of:
installing a device for monitoring an operating state of a control device of the passenger transport system, so that optical indicators of the control device can be detected. The device is preferably a device as described above and below.

This also allows existing passenger transport systems to be modernized in a simple manner, without electrical signals of the control device having to be tapped for this purpose. This allows the control device to be monitored remotely.

### DESCRIPTION OF THE DRAWINGS

In the following, the invention is further explained in drawings with reference to embodiments, in which:

FIG. 1: is a schematic view of a first embodiment of a device for monitoring an operating state of a control device of a passenger transport system;

FIG. 2: is a schematic view of a second embodiment of a device for monitoring an operating state of a control device of a passenger transport system; and

FIG. 3: is a schematic view of a third embodiment of a device for monitoring an operating state of a control device of a passenger transport system.

### DETAILED DESCRIPTION

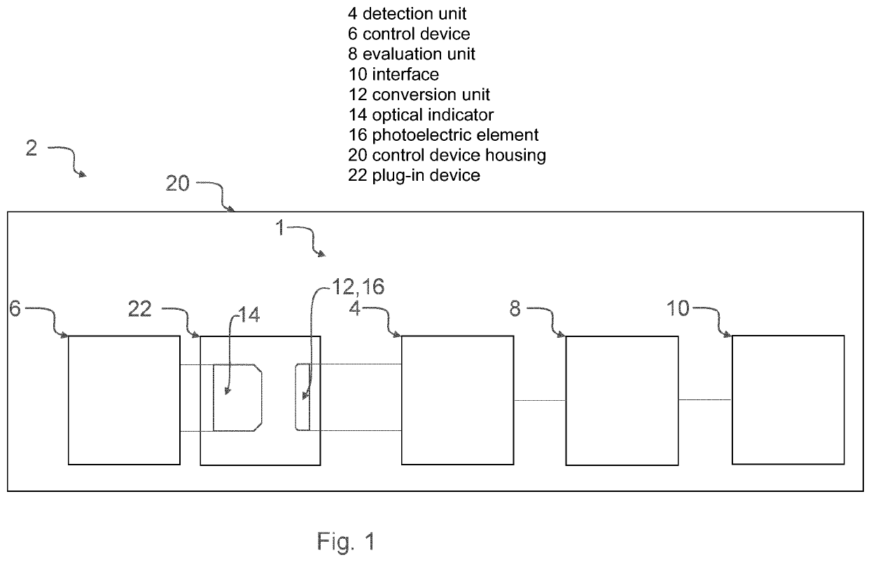

FIG. 1 shows a passenger transport system 2 having a control device 6. The control device 6 is accommodated in a control device housing 20 and has an optical indicator 14. A device 1 for monitoring an operating state of a control device 6 of the passenger transport system 2 is present in the control device housing 20. The device 1 comprises a detection unit 4, which comprises a conversion unit 12, which in this embodiment is designed as a photoelectric element 16. The detection unit 4 is connected to an evaluation unit 8, the evaluation unit 8 in turn being connected to an interface 10 for communication.

The conversion device also has a plug-in device 22 that can be plugged onto the one optical indicator 14 of the control device.

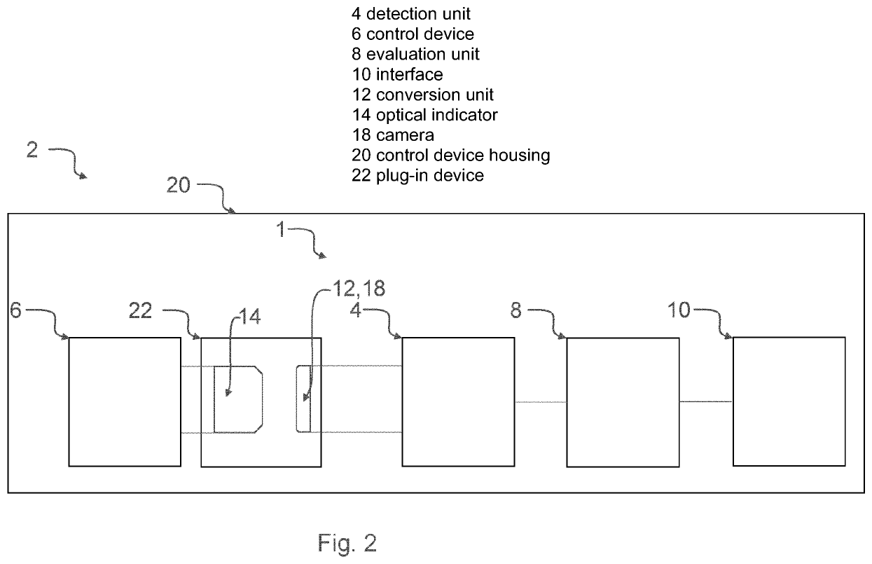

In the embodiment in FIG. 2, the conversion device 12 is designed as a camera 18.

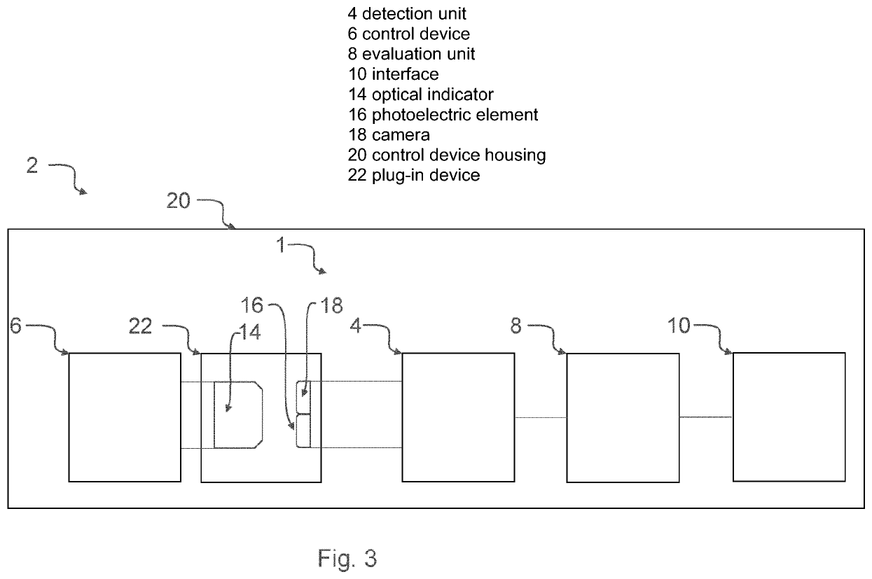

In the embodiment in FIG. 3, the conversion device 12 comprises a photoelectric element 16 and a camera 18.

In accordance with the provisions of the patent statutes, the present invention has been described in what is considered to represent its preferred embodiment. However, it should be noted that the invention can be practiced otherwise than as specifically illustrated and described without departing from its spirit or scope.

1-11. (canceled)

12. A device for monitoring an operating state of a control device of a passenger transport system, the device comprising:
a detection unit detecting a signaled state of the control device and generating a first electrical quantity depending on the detected signaled state;
an evaluation unit analyzing the first electrical quantity in relation to an operating state of the control device and generating a second electrical quantity dependent on the analysis of the first electrical quantity;
an interface transmitting the second electrical quantity;
wherein the detection unit includes a conversion device for converting an optical signal of at least one optical indicator of the control device into the first electrical quantity;
wherein the conversion device has at least one plug-in device that is adapted to be plugged onto at least one optical indicator of the control device; and
wherein the at least one plug-in device has at least one of a photoelectric element and a camera for monitoring the indicator and faces the at least one optical indicator when the plug-in device is plugged onto the at least one optical indicator.

13. The device according to claim 12 wherein the photoelectric element is a photoresistor.

14. The device according to claim 12 wherein the conversion device is adapted to be mounted in a control device housing that accommodates the control device and to monitor a plurality of the at least one optical indicators in the control device housing.

15. The device according to claim 12 wherein the plug-in device includes a camera monitoring at least one further optical indicator and faces away from the at least one optical indicator when the plug-in device is plugged onto the at least one optical indicator.

16. A method for retrofitting an existing passenger transport system, the method comprising the step of: installing the device according to claim 12 on an existing passenger transport system such that optical indicators of a control device of the existing passenger transport system are detected by the device.

17. A method for monitoring an operating state of a control device of a passenger transport system, the method comprising the steps of:
optically monitoring at least one optical indicator of the control device;
generating an electrical signal corresponding to an optical state of the at least one optical indicator;
detecting a change in the optical state of the at least one optical indicator based on a change in the electrical signal; and
evaluating the detected change in the optical state to determine the operating state of the control device.

18. The method according to claim 17 including continuously optically monitoring the at least one optical indicator.

19. The method according to claim 17 wherein the detection of the change in the optical state of the at least one optical indicator includes identifying a change in at least one of color, state change patterns and a one-time switch-off and/or switch-on.

20. The method according to claim 19 wherein the state change patterns include at least one of on-off patterns and intensity change patterns.

21. The method according to claim 17 including performing the steps in a learning phase during which the evaluating of the detected change in the optical state is used to define an operating state of at least one of the control device and the passenger transport system.

22. The method according to claim 17 including performing the steps in a monitoring phase during which the evaluating of the detected change in the optical state is used to identify an error state of at least one of the control device and the passenger transport system.

23. The method according to claim 17 including a step of transmitting the detected change in the optical state to an entity outside the passenger transport system.

24. The method according to claim 17 including a step of resetting the control device when a specific error state of the control device or passenger transport system is identified.
